(19) United States
(12) Patent Application Publication
(10) Pub. No.: US 2026/0188336 A1
(43) Pub. Date: Jul. 2, 2026

(54) DYNAMIC MANAGEMENT OF NOISE SUPPRESSION MODELS IN COMMUNICATION SYSTEMS

(71) Applicant: MOTOROLA SOLUTIONS, INC., Chicago, IL (US)

(72) Inventors: Harvey D. Chambers, Sunrise, FL (US); Cesar D. Aguilar, Weston, FL (US); Jesus F. Corretjer, Weston, FL (US); Jeet K. Pawani, Sunrise, FL (US); Kheng Shiang Teh, Bayan Lepas (MY)

(21) Appl. No.: 19/002,130

(22) Filed: Dec. 26, 2024

(51) Int. Cl. G10L 21/0216; H04W 84/04

(52) U.S. Cl. CPC G10L 21/0216; H04W 84/042

(57) ABSTRACT

A transmitting mobile device includes non-transitory computer-readable media storing instructions and an electronic processor configured to execute the instructions to transmit a query to a plurality of receiving mobile devices requesting an audio quality metric for an audio transmission from the transmitting mobile device as received by each receiving mobile device, the plurality of receiving mobile devices and the transmitting mobile device being part of a land mobile radio call group, receive a response from each receiving mobile device, each response including the audio quality metric, determine a count of receiving mobile devices reporting audio quality metrics below a first threshold, and in response to the count being below a second threshold, adjust an aggressiveness level of a first noise suppression model at the transmitting mobile device.

### BACKGROUND OF THE INVENTION

Examples described herein relate to noise suppression in communication systems.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate examples of concepts that include the claimed invention, and explain various principles and advantages of those embodiments.

FIG. 1 is a block diagram illustrating a communications system, according to some examples.

FIG. 2 is a block diagram illustrating optional additional features of the communications system of FIG. 1, according to some examples.

FIG. 3 is a block diagram illustrating a transmitting mobile device, according to some examples.

FIG. 4 is a block diagram illustrating a receiving mobile device, according to some examples.

FIG. 5 is a block diagram illustrating an orchestration platform, according to some examples.

FIG. 6 is a flowchart of a process for determining whether adjustments to noise suppression models are needed at a transmitting mobile device or at one or more receiving mobile devices, according to some examples.

FIG. 7 is a flowchart of a process for adjusting an aggressiveness of a noise suppression model at a transmitting mobile device, according to some examples.

FIG. 8 is a flowchart of a process for adjusting an aggressiveness of a noise suppression model at one or more receiving mobile devices, according to some examples.

FIG. 9 is a flowchart of a process for automatically configurating a noise suppression model based on a location of a mobile device, according to some examples.

FIG. 10 is a flowchart of a process for configuring a noise suppression model at a receiving mobile device, according to some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples of the present invention.

The apparatus and method components have been represented where appropriate by conventional symbols in the drawings, showing only those specific details that are pertinent to understanding the examples of the present invention so as not to obscure the disclosure with details that will be readily apparent to those of ordinary skill in the art having the benefit of the description herein.

### DETAILED DESCRIPTION OF THE INVENTION

Noise suppression models may be deployed to mobile devices in communication systems, such as narrowband land mobile radio (LMR) systems, to enhance audio quality and intelligibility, and such communication systems face technical challenges in managing noise suppression to ensure optimal audio quality and intelligibility. These challenges include selecting appropriate noise suppression models and balancing aggressiveness levels of such models across transmitting and receiving mobile devices, particularly in environments with dynamic and varied noise (e.g., fluctuating ambient or transmission channel noise), which may be referred to herein “varied noise environments.” For example, these models may be implemented in transmitting mobile devices and/or receiving mobile devices to mitigate ambient noise and/or transmission channel noise at their respective ends. While the deployment of noise suppression models generally improves audio quality and intelligibility, the proper selection of models and the management of model aggressiveness levels can present technical challenges. Improper selection or coordination of models and/or mismanagement of aggressiveness levels may result in overprocessing, underprocessing, or mismatched noise suppression strategies, degrading overall performance.

For example, technical challenges may arise from the improper configuration of noise suppression models, particularly in scenarios where both the transmitting mobile device and the receiving mobile device include active noise suppression models. The combined effect of the aggressiveness levels at both ends may result in overprocessing or underprocessing of the audio signal. For instance, when the transmitting mobile device applies an overly aggressive level of noise suppression, significant portions of the speech signal may be attenuated along with the noise. When this already-attenuated signal reaches the receiving mobile device, further processing by a noise suppression model at the receiving mobile device may amplify distortions or render the signal unintelligible. Conversely, when the transmitting mobile device applies insufficient suppression, excess ambient noise may remain in the signal, requiring the receiving mobile device to apply higher suppression levels, which may degrade the audio signal.

Managing noise suppression aggressiveness may present additional challenges in varied noise environments. For example, when the transmitting mobile device applies a fixed suppression level without accounting for changes in the varied noise environment, the receiving mobile device may struggle to process the signal optimally. In some cases, both devices may inadvertently apply excessive suppression to compensate for perceived noise, resulting in overprocessed signals with distorted or missing speech elements. In other cases, both devices may apply insufficient suppression, leaving disruptive noise in the audio signal and degrading intelligibility.

Technical challenges associated with managing aggressiveness levels may become more pronounced in group call scenarios, where multiple receiving mobile devices operate in one or more environments, which may experience different noise. In such cases, the transmitting mobile device's noise suppression level may impact multiple receiving devices simultaneously, but each receiving device may require a different level of additional suppression to address the unique noise conditions of each receiving device. When the transmitting device applies too much suppression, the suppression applied by the transmitting device may limit the ability of receiving devices to refine the audio signal for the specific needs of the receiving device. Conversely, when the transmitting device applies too little suppression, the suppression applied by the transmitting device may shift the burden to the receiving devices, increasing the likelihood of overprocessing or residual noise at some or all receiving devices. Without dynamic coordination of noise suppression levels between the transmitting and receiving mobile devices, these imbalances may degrade audio quality and intelligibility across the communication system.

Additionally, the improper selection of noise suppression models may create further technical challenges. Transmitting and receiving mobile devices may encounter distinct types of noise based on their roles and operating environments. For example, transmitting mobile devices may primarily encounter ambient noise, such as acoustic or environmental sounds in their immediate surroundings (e.g., machinery, crowd noise, or weather-related noise). In contrast, receiving mobile devices may need to address not only ambient noise but also transmission channel noise, such as RF-induced interference, fading, and other distortions introduced during signal propagation. Using a single noise suppression model across both transmitting and receiving mobile devices may fail to address these distinct noise profiles effectively, potentially leading to suboptimal noise reduction. For example, a model optimized for mitigating ambient noise at the transmitting mobile device may not adequately handle transmission channel noise at the receiving mobile device. This mismatch may degrade audio quality and intelligibility, particularly in complex noise environments or group calls involving multiple receiving devices.

The selection of noise suppression models may be further complicated when different devices are impacted by different types of noise. For example, transmitting mobile devices may suffer from the device picking up ambient noise, as they may be exposed to environmental sounds such as background conversations or traffic, which may be introduced to the transmitted audio signal as noise. Receiving mobile devices, on the other hand, often face challenges resulting from transmission channel noise. Transmission channel noise may result from distortions such as static, packet loss, or RF interference that occur as the audio signal travels from the transmitting mobile device to the receiving mobile device. When mobile devices are pre-loaded with static noise suppression models that cannot adapt to these differing noise types, maintaining consistent audio quality becomes challenging, especially in dynamically changing environments.

Systems, apparatuses, methods, and techniques described in this specification provide technical solutions to these challenges (among others) by facilitating the automatic selection of noise suppression models and/or the dynamic adjustment of aggressiveness levels for the models at transmitting mobile devices and/or receiving mobile devices. These technical solutions may support the selection of an optimal noise suppression model for the transmitting and/or receiving mobile devices based on actual operating conditions, such as ambient noise or transmission channel noise. Additionally, these technical solutions may dynamically adjust the aggressiveness levels of the models as needed to suit the prevailing conditions, achieving a balance or “sweet spot” that ensures optimal audio quality and intelligibility.

For example, the transmitting mobile device (or optionally, an orchestration platform) may determine whether adjustments are needed at the transmitting device itself or at one or more receiving devices. This determination may be based on audio quality metrics received from the receiving mobile devices. When metrics indicate that multiple receiving devices are experiencing audio degradation, the transmitting mobile device (or the orchestration platform) may identify the issue as originating from its own noise suppression model and adjust its aggressiveness levels accordingly. Alternatively, when the metrics show that only specific receiving devices have degraded audio quality, adjustments may be made at those receiving devices.

In response to the transmitting mobile device (or the orchestration platform) determining that adjustments are needed at the transmitting end, it may dynamically adjust the aggressiveness level of the noise suppression model applied at the transmitting mobile device to improve the quality of the transmitted signal. Conversely, when adjustments are required at the receiving mobile devices, the transmitting mobile device (or the orchestration platform) may send commands to those devices, instructing them to modify their model aggressiveness levels. This targeted approach may offer particular advantages in group call scenarios, where receiving mobile devices may operate in diverse noise conditions. By tailoring suppression strategies for individual receiving mobile devices, the system improves signal processing. Additionally, various devices may be automatically configured with noise suppression models based on their role as a transmitting or receiving mobile device. For example, transmitting devices may be configured with models optimized for addressing ambient noise, while receiving mobile devices may be configured with models optimized for addressing transmission channel noise, ensuring optimal audio clarity by addressing the specific noise challenges faced by each type of device.

Techniques described herein may also address the challenge of selecting appropriate noise suppression models based on location, environmental conditions, device role, etc. For example, transmitting and/or receiving mobile devices may use geolocation data to activate noise suppression models optimized for specific noise environments. When a device enters a predefined area with known noise characteristics, it may automatically switch to a model tailored to mitigate those noise types, ensuring consistent performance without manual adjustments.

Additionally, transmitting mobile devices may transmit metadata or noise type identifiers with the audio signal, allowing receiving devices to select the most suitable suppression model for processing the received signal. This coordinated approach ensures that each device applies a model optimized for its specific noise profile, minimizing residual noise and improving audio intelligibility.

By integrating dynamic feedback mechanisms, adaptive model selection, and/or location-based adjustments, systems, apparatuses, methods, and techniques described herein provide comprehensive solutions for managing noise suppression in communication systems. These features ensure that both transmitting and receiving mobile devices work in tandem to maintain optimal audio quality in complex and dynamic environments.

According to some examples, a transmitting mobile device includes non-transitory computer-readable media storing instructions and an electronic processor configured to execute the instructions to transmit a query to a plurality of receiving mobile devices requesting an audio quality metric for an audio transmission from the transmitting mobile device as received by each receiving mobile device, the plurality of receiving mobile devices and the transmitting mobile device being part of a land mobile radio call group, receive a response from each receiving mobile device, each response including the audio quality metric, determine a count of receiving mobile devices reporting audio quality metrics below a first threshold, and in response to the count being below a second threshold, adjust an aggressiveness level of a first noise suppression model at the transmitting mobile device.

In other features, the electronic processor is further configured to execute the instructions to after adjusting the aggressiveness level of the first noise suppression model, transmit a second query to the plurality of receiving mobile devices for an updated audio quality metric from each receiving mobile device, receive an updated response from each receiving mobile device, each updated response including the updated audio quality metric, determine an updated count of receiving mobile devices reporting updated audio quality metrics below the first threshold, and, in response to the updated count being below the second threshold, further adjust the aggressiveness level of the first noise suppression model.

In other features, the electronic processor is further configured to execute the instructions to, in response to the count not being below the second threshold, transmit a first command to a selected receiving mobile device from the plurality of receiving mobile devices in response to the audio quality metric reported by the selected receiving mobile device being below the first threshold, the first command instructing the selected receiving mobile device to adjust an aggressiveness level of a second noise suppression model at the selected receiving mobile device.

In other features, the electronic processor is further configured to execute the instructions to, after transmitting the first command, receive an updated response message including an updated audio quality metric from the selected receiving mobile device and, in response to determining that the updated audio quality metric is below the first threshold, transmit a second command to the selected receiving mobile device, the second command instructing the selected receiving mobile device to adjust the aggressiveness level of the second noise suppression model.

In other features, the electronic processor is further configured to execute the instructions to adjust the aggressiveness level of the first noise suppression model by increasing or decreasing a noise suppression level of the first noise suppression model. In other features, the electronic processor is further configured to execute the instructions to, in response to determining that a location of the transmitting mobile device is within a defined area, activate a noise suppression model corresponding to the defined area as the first noise suppression model.

In other features, the electronic processor is further configured to execute the instructions to, in response to determining that a location of the transmitting mobile device is within a defined area, select an aggressiveness level for the first noise suppression model corresponding to the defined area. In other features, the electronic processor is further configured to execute the instructions to, in response to determining that an audio accessory is connected to the transmitting mobile device, activate a third noise suppression model, the third noise suppression model being less aggressive than the first noise suppression model, and transmit an indication that the audio accessory is connected to at least one of the plurality of receiving mobile devices. The audio accessory includes a single-microphone audio accessory.

Other examples provide a non-transitory computer-readable storage medium includes executable instructions. When executed by an electronic processor, the executable instructions cause the electronic processor to transmit a query to a plurality of receiving mobile devices requesting an audio quality metric for an audio transmission from a transmitting mobile device as received by each receiving mobile device, the plurality of receiving mobile devices and the transmitting mobile device being part of a land mobile radio call group, receive a response from each receiving mobile device, each response including the audio quality metric, determine a count of receiving mobile devices reporting audio quality metrics below a first threshold, and in response to the count being below a second threshold, adjust an aggressiveness level of a first noise suppression model at the transmitting mobile device.

In other features, when executed by the electronic processor, the executable instructions cause the electronic processor to adjust the aggressiveness level of the first noise suppression model at the transmitting mobile device by transmitting a first command to the transmitting mobile device.

In other features, when executed by the electronic processor, the executable instructions further cause the electronic processor to after adjusting the aggressiveness level of the first noise suppression model, transmit a second query to the plurality of receiving mobile devices for an updated audio quality metric from each receiving mobile device, receive an updated response from each receiving mobile device, each updated response including the updated audio quality metric, determine an updated count of receiving mobile devices reporting updated audio quality metrics below the first threshold, and, in response to the updated count being below the second threshold, transmit a second command to the transmitting mobile device to further adjust the aggressiveness level of the first noise suppression model.

In other features, when executed by the electronic processor, the executable instructions further cause the electronic processor to, in response to the count not being below the second threshold, transmit a first command to a selected receiving mobile device from the plurality of receiving mobile devices in response to the audio quality metric reported by the selected receiving mobile device being below the first threshold, the first command instructing the selected receiving mobile device to adjust an aggressiveness level of a second noise suppression model at the selected receiving mobile device.

In other features, when executed by the electronic processor, the executable instructions further cause the electronic processor to, after transmitting the first command, receive an updated response message including an updated audio quality metric from the selected receiving mobile device and, in response to determining that the updated audio quality metric is below the first threshold, transmit a second command to the selected receiving mobile device, the second command instructing the selected receiving mobile device to adjust the aggressiveness level of the second noise suppression model.

In other features, when executed by the electronic processor, the executable instructions cause the electronic processor to adjust the aggressiveness level of the first noise suppression model by increasing or decreasing a noise suppression level of the first noise suppression model. In other features, when executed by the electronic processor, the executable instructions further cause the electronic processor to, in response to determining that a location of the transmitting mobile device is within a defined area, activate a noise suppression model corresponding to the defined area as the first noise suppression model and select an aggressiveness level for the first noise suppression model corresponding to the defined area.

In other features, when executed by the electronic processor, the executable instructions cause the electronic processor to activate the noise suppression model corresponding to the defined area as the first noise suppression model and select an aggressiveness level for the first noise suppression model by transmitting a third command to the transmitting mobile device. In other features, when executed by the electronic processor, the executable instructions cause the electronic processor to, in response to determining that a location of the selected receiving mobile device is within a defined area, transmit a fourth command to the selected receiving mobile device to activate a noise suppression model corresponding to the defined area as the second noise suppression model and select an aggressiveness level for the second noise suppression model corresponding to the defined area.

In some examples, a receiving mobile device includes non-transitory computer-readable media storing instructions and an electronic processor configured to execute the instructions to receive a data transmission from a transmitting mobile device, the transmitting mobile device and the receiving mobile device being part of a land mobile radio call group, the data transmission including an indication of whether a first noise suppression model is operating at the transmitting mobile device, in response to determining that the first noise suppression model is operating at the transmitting mobile device, activate a second noise suppression model at the receiving mobile device, in response to determining that the first noise suppression model is not operating at the transmitting mobile device, activate a third noise suppression model at the receiving mobile device, receive a command from the transmitting mobile device, and, in response to receiving the command, adjust an aggressiveness level of the activated noise suppression model by increasing or decreasing a noise suppression level of the activated noise suppression model.

In other features, the electronic processor is further configured to execute the instructions to, in response to determining that a location of the receiving mobile device is within a defined area, activate a fourth noise suppression model corresponding to the defined area and select an aggressiveness level for the activated noise suppression model corresponding to the defined area. In other features, the second noise suppression model is configured to suppress noise introduced by a radio-frequency transport channel noise and the third noise suppression model is configured to suppress an audible noise at the transmitting mobile device.

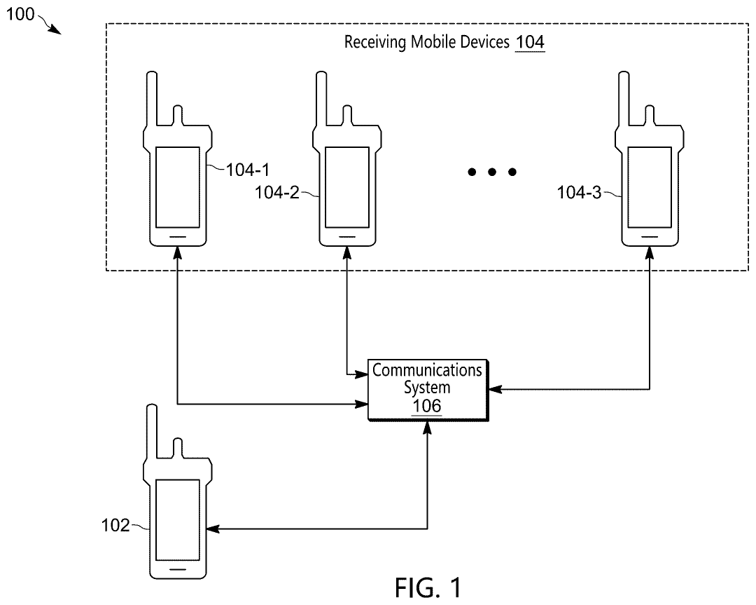

FIG. 1 is a block diagram illustrating a communications system 100, according to some examples. In the implementation of FIG. 1, the communications system 100 includes a transmitting mobile device 102 and one or more receiving mobile devices 104, such as receiving mobile devices 104-1, 104-2, and 104-3. Although three receiving mobile devices 104 are illustrated in the example of FIG. 1, in other implementations, the communications system 100 may include any number of receiving mobile devices 104. In some examples, the transmitting mobile device 102 and the receiving mobile devices 104 may be land mobile radio system radios. The transmitting mobile device 102 and the receiving mobile devices 104 may communicate over a communications system 106.

The communications system 106 may facilitate radio frequency (RF) communication between the transmitting mobile device 102 and/or the receiving mobile devices 104. For example, the transmitting mobile device 102 and the receiving mobile devices 104 may each include transceivers capable of handling unidirectional or bidirectional audio and/or data transmissions via communications system 106. Examples of audio transmissions include analog and/or digital data transmissions. Examples of data transmissions may include metadata about the audio transmissions and/or states of the respective mobile devices (such as, for example, indications of noise suppression being applied, audio quality metrics related to the audio transmissions between the devices, location data related to respective mobile devices, and/or other parameters relevant to maintaining optimal communication quality between the mobile devices) and/or commands to various mobile devices to adjust noise suppression models deployed to the respective devices.

The communications system 106 may include a land mobile radio system implemented according to various standards and protocols, such as the Project 25 (P25 ) standard developed by the Association of Public-Safety Communications Officials (APCO), the Terrestrial Trunked Radio (TETRA) specification, the Digital Mobile Radio (DMR) standard, the Next Generation Digital Narrowband (NXDN) standard, the Digital Private Mobile Radio (dPMR) standard, and/or the OpenSky standard, among other suitable standards and protocols. These standards and protocols may provide reliable and interoperable communication solutions for public safety, commercial, and/or private use.

In various implementations, the transmitting mobile device 102 and the receiving mobile devices 104 communicate directly via a radio link between the respective transceivers at each device, facilitating device-to-device interaction. In some examples, the communications system 106 includes infrastructure such as repeaters, mesh networks, and/or base stations to enhance connectivity and reliability. Repeaters may operate by receiving a signal, amplifying the signal, and retransmitting the amplified signal to extend the communication range, particularly in environments with physical obstructions or over large distances. Mesh networks may include interconnected devices or nodes that relay data dynamically, ensuring robust and adaptive communication paths. Base stations may serve as centralized hubs that coordinate communication between devices, manage channel allocation, and connect mobile devices to broader networks when needed. By integrating these transmission methods and protocols, the communications system 106 may help ensure efficient, adaptable, and high-quality communication between transmitting and receiving mobile devices, even in complex and challenging operating environments.

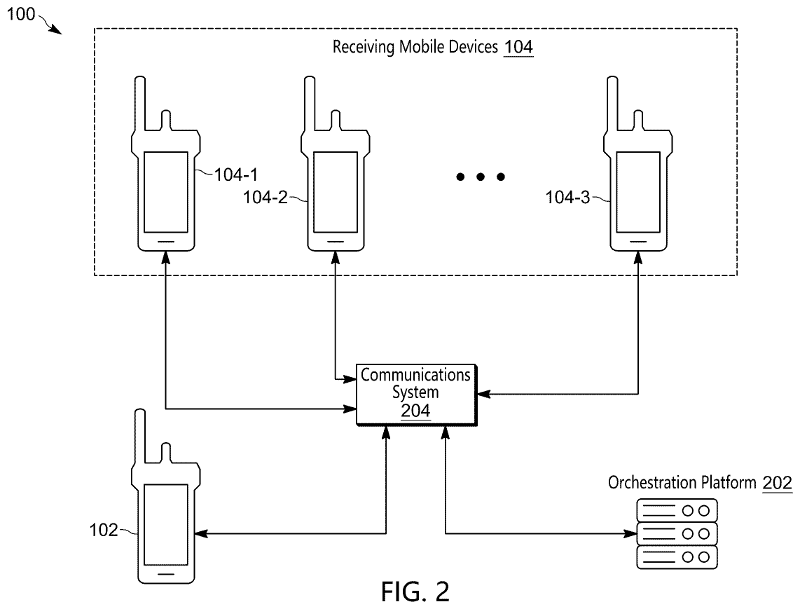

FIG. 2 is a block diagram illustrating optional additional features of the communications system 100, according to some examples. In the implementation of FIG. 2, the communications system 100 additionally includes an orchestration platform 202 and the transmitting mobile device 102, receiving mobile devices 104, and/or the orchestration platform 202 may also communicate with one another via the communications system 204. As described in detail below, functionality described herein—particularly functionality related to managing the configuration of noise suppression models across system 100—may, in some examples, be implemented via the orchestration platform 202. For example, instead of the transmitting mobile device 102, the orchestration platform 202 may be configured to perform various functions related to the automatic selection and/or the dynamic configuration of noise suppression models deployed to the transmitting mobile device 102 and/or the receiving mobile devices 104.

The orchestration platform 202 may include one or more computing platforms deployed in various configurations suited to various operational requirements. For example, the orchestration platform 202 may be deployed as a local server, multiple distributed servers, as part of a scalable cloud infrastructure, or any combination of these deployment models. The communications system 204 may facilitate data transmissions between the transmitting mobile device 102, receiving mobile devices 104, and/or the orchestration platform. Examples of data transmissions include metadata about the audio transmissions and/or states of the respective mobile devices (such as, for example, any of the previously described metadata) and/or commands to various mobile devices to adjust noise suppression models deployed to the respective devices.

In various implementations, the transmitting mobile device 102, the receiving mobile devices 104, and/or the orchestration platform may each include transceivers for transmitting and/or receiving data transmissions via the communications system 204. The communications system 204 may include one or more networks, such as a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In some examples, the communications system 204 includes an optical network, a local area network, and/or a global communication network, such as the Internet.

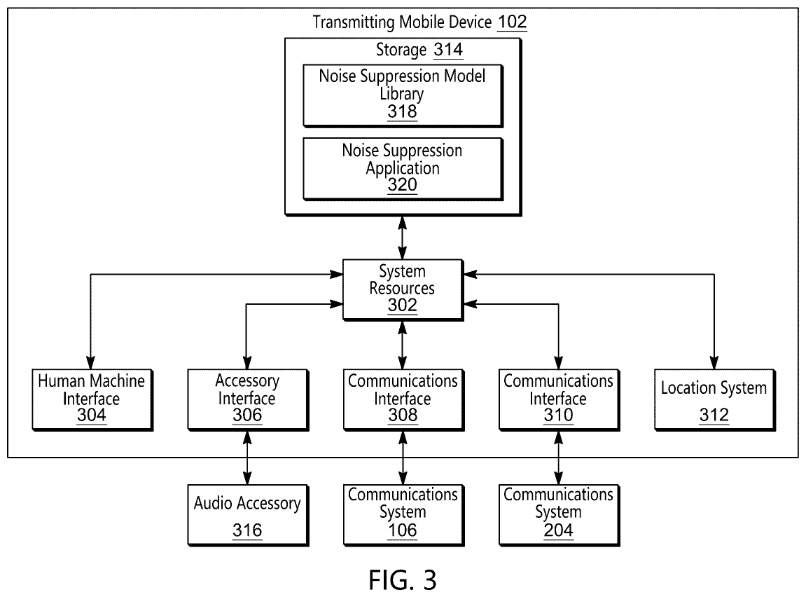

FIG. 3 is a block diagram illustrating a transmitting mobile device 102, according to some examples. In the implementation of FIG. 3, the transmitting mobile device 102 includes system resources 302, human machine interfaces 304, an accessory interface 306, a communications interface 308, a communications interface 310, a location system 312, and/or non-transitory computer-readable storage media such as storage 314. The system resources 302 may include one or more electronic processors and/or one or more graphics processing units for executing instructions stored in the storage 314, volatile computer memory, non-volatile computer memory, and/or one or more system buses interconnecting the components of the transmitting mobile device 102 (such as any of the previously described components).

The human machine interfaces 304 may include one or more input devices and/or one or more output devices designed to facilitate user interaction and/or enhance operational functionality. Examples of input devices include a microphone or microphone array for capturing audio, a push-to-talk (PTT) button for initiating voice communication, a keypad for dialing or entering commands, one or more rotary knobs for adjusting settings (e.g., volume or channel selection), additional programmable buttons for specific functions, toggle switches for mode selections, and/or a touchscreen interface for interacting with the transmitting mobile device 102. Examples of output devices include a display (e.g., an LCD or OLED screen) to present information (such as channel settings, signal strength, messages, etc.), speakers for audio playback, indicator lights (e.g., LEDs) to provide visual feedback on device status (such as power, connectivity, and/or call status), and/or haptic devices (e.g., vibration motors) that provide tactile alerts for events such as incoming calls or system notifications.

The accessory interface 306 may include one or more connection mechanisms designed to attach an audio accessory 316 to the transmitting mobile device 102, enhancing its functionality and adaptability in various use cases. The audio accessory 316 may include an external microphone for capturing high-quality audio, a speaker microphone that integrates audio input and output in a single device, a headset for hands-free operation, and/or other audio devices compatible with land mobile radio system devices. The accessory interface 306 may support wired connections, such as through a standardized audio jack or proprietary connector, and/or wireless connections, such as Bluetooth, to accommodate diverse operational requirements and user preferences.

The accessory interface 306 may also facilitate the transmission of control signals between the transmitting mobile device 102 and the attached audio accessory 316. For example, the accessory interface 306 can relay push-to-talk (PTT) commands or adjust audio processing parameters based on the accessory's capabilities. By supporting a wide range of audio accessories, the accessory interface 306 enhances the versatility of the transmitting mobile device 102, facilitating seamless operation in various environments, including high-noise or hands-free scenarios.

The communications interface 308 may include one or more components configured to facilitate communication via the communications system 106. For example, the communications interface 308 may include one or more transceivers and associated circuitry for handling RF communications, allowing the transmitting mobile device 102 to send and/or receive unidirectional or bidirectional audio and/or data transmissions over the communications system 106. The communications interface 310 may include one or more components configured to facilitate communication via the communications system 204. For example, the communications interface 310 may include one or more transceivers and associated circuitry for handling data communications via the communications system 204.

The location system 312 may include one or more components configured to determine the geographic location of the transmitting mobile device 102. For example, the location system 312 may include a satellite receiver capable of utilizing signals from satellite positioning systems to calculate a precise location of the transmitting mobile device 102 (for example, by triangulating distances between the transmitting mobile device 102 and satellites in orbit). The satellite receiver may receive signals from global navigation satellite systems (GNSSs) such as the Global Positioning System (GPS), GLONASS, Galileo, BeiDou, etc.

In various implementations, the location system 312 includes a cellular radio capable of detecting signals from multiple cell towers to determine the location of the transmitting mobile device 102 through cellular tower triangulation. In some examples, the location system 312 includes a Wi-Fi transceiver and identifies nearby access points to estimate the location of the transmitting mobile device 102 (for example, by comparing known locations of access points against signal strength or timing data to estimate the location).

In the example of FIG. 3, the storage 314 includes a noise suppression model library 318 and a noise suppression application 320. The noise suppression model library 318 may include one or more noise suppression models implemented using artificial intelligence (AI) and/or machine learning (ML) techniques, as well as one or more models implemented using deterministic signal processing methods. These noise suppression models may process input audio signals (for example, captured by the transmitting mobile device 102) and reduce or eliminate noise present in the audio signal while preserving speech quality, intelligibility, and other desirable audio characteristics.

In various implementations, the AI/ML-based noise suppression models in the noise suppression model library 318 may receive a raw or preprocessed audio signal as input. This input audio signal may contain both speech and various types of noise, such as ambient noise and/or transmission channel noise. The models may process the input to suppress or remove unwanted noise components and produce an output audio signal with enhanced clarity, quality, intelligibility, etc.

To address ambient or environmental noise, AI/ML-based noise suppression models may employ architectures such as convolutional neural networks (CNNs). The CNNs may receive spectrogram representations of the input audio signal, depicting the frequency content over time. By analyzing these spectrograms, the CNNs can identify and suppress noise patterns based on their spatial features within the frequency spectrum. The output may be an audio signal with reduced ambient noise, preserving the desired speech components. CNNs may be particularly effective at removing stationary or slowly varying ambient noises, such as machinery hum, steady traffic noise, or constant crowd chatter.

Recurrent neural networks (RNNs), including long short-term memory (LSTM) networks, may be used to mitigate dynamic noise that changes over time. The RNNs may receive the input audio signal as a sequence of time steps, allowing the models to capture temporal dependencies and patterns in the audio data. By processing this sequential data, the RNNs can distinguish between speech and time-varying noise. The output may be an audio signal where dynamic noise components, such as fluctuating wind noise or intermittent background sounds, are suppressed. RNNs may be well-suited for environments with non-stationary noise because they can model the temporal evolution of the noise and adapt accordingly.

Hybrid architectures, such as convolutional recurrent neural networks (CRNNs), may combine the strengths of CNNs and RNNs to address both spatial and temporal noise patterns. The CRNNs may process the input audio signal by first transforming it into spectrograms and applying convolutional layers to extract spatial features related to frequency content. These features may then be passed through recurrent layers to capture temporal dynamics. The output may be an audio signal with both stationary and dynamic noise components reduced. CRNNs may effectively remove complex noise types that have both spectral and temporal variations, making them suitable for environments with multiple overlapping noises.

To address transmission channel noise, AI/ML-based noise suppression models may employ architectures such as deep neural networks (DNNs) and autoencoders. The DNNs may receive the input audio signal—which may include speech and transmission channel noise—as a sequence of feature vectors extracted from the audio data. By applying multiple layers of nonlinear transformations, the DNNs can learn complex patterns associated with transmission-induced distortions and suppress them while preserving the speech components. The output may be an audio signal with transmission channel noise attenuated, enhancing speech quality and intelligibility. DNNs may be particularly effective at mitigating noise introduced during signal propagation, such as RF-induced interference, static, multi path fading, and distortions resulting from bandwidth limitations.

Autoencoders may process the input audio signal by encoding it into a compressed representation and then reconstructing it. The encoder component may transform the input into a lower-dimensional space, capturing essential features of the speech signal while filtering out noise components that do not match the learned patterns of clean speech. The decoder may then reconstruct the audio signal from this compressed representation. The output may be a clean audio signal with transmission channel noise effectively removed. Autoencoders may be well-suited for eliminating noise patterns that differ from the learned representation of clean speech, making them effective at removing transmission channel noise such as static and interference.

In scenarios where both ambient noise and transmission channel noise are present, AI/ML-based noise suppression models may employ architectures such as deep convolutional recurrent neural networks (DCRNNs). The DCRNNs may receive the input audio signal, represented as spectrograms or sequences of feature vectors that capture both spectral and temporal information. The convolutional layers may extract spatial features related to frequency content, focusing on patterns indicative of ambient noise. The recurrent layers may model temporal dependencies, capturing the dynamics of both speech and noise over time. By processing the input through both convolutional and recurrent layers, the DCRNNs can simultaneously address spatial and temporal noise patterns. The output may be an audio signal with both ambient noise and transmission channel noise suppressed, preserving the integrity of the speech signal. DCRNNs may be particularly effective in challenging environments where multiple noise types coexist, such as urban settings with fluctuating background noises and transmission distortions.

In contrast to AI/ML-based models, deterministic noise suppression models may rely on established signal processing techniques to mitigate noise. These models may use predefined algorithms or rules to attenuate noise based on identifiable characteristics, such as specific frequency ranges, amplitude patterns, or temporal behaviors. Deterministic noise suppression models may be computationally efficient and may be especially suitable for real-time applications where computational resources are limited.

To address ambient or environmental noise, deterministic noise suppression models may receive the input audio signal captured by the transmitting mobile device 102, which may contain both speech and ambient noise. The models may process this input using techniques such as spectral subtraction, Wiener filtering, adaptive filtering, etc. Spectral subtraction may include estimating the noise spectrum during periods of silence or low speech activity by analyzing the input audio signal. The estimated noise spectrum may then be subtracted from the noisy signal, enhancing the speech components. The output may be an audio signal with reduced ambient noise. Spectral subtraction may be effective in reducing stationary background noises like constant machinery hum or air conditioning noise.

Wiener filtering may include minimizing the mean square error between the estimated clean signal and the actual clean signal by adapting the filter response based on the statistical properties of the signal and noise. The input audio signal may be processed through the Wiener filter, balancing noise reduction and speech distortion. The output may be an audio signal with attenuated noise and preserved speech quality. Wiener filtering may be suitable for environments where noise characteristics are relatively constant.

Adaptive filtering techniques, such as the least mean squares (LMS) and recursive least squares (RLS) algorithms, may include adjusting filter coefficients in real-time in response to the input audio signal. These models can track changes in the noise environment by continuously updating filter parameters. The output may be an audio signal where time-varying noise components are suppressed. Adaptive filtering may be beneficial in environments with varying ambient noise levels, such as fluctuating crowd noise or intermittent machinery sounds.

To address transmission channel noise, deterministic noise suppression models may process the input audio signal affected by distortions introduced during signal propagation. The models may employ methods like channel equalization, de-noising filters, error correction algorithms, etc. Channel equalization may include applying inverse filtering to the input audio signal to compensate for distortions such as multipath fading and bandwidth limitations. By restoring the original signal characteristics, the output may be an audio signal with corrected transmission-induced distortions.

De-noising filters, such as low-pass, high-pass, and/or band-pass filters, may remove unwanted frequency components caused by RF interference and/or static. The input audio signal may be filtered to attenuate frequencies outside the desired range. For example, a band-pass filter can isolate the frequency range of human speech, reducing out-of-band noise. The output may be an audio signal with reduced transmission channel noise. Error correction algorithms, such as forward error correction (FEC) codes, can detect and correct errors in the transmitted data without the need for retransmission. By processing the input audio signal encoded with error correction codes, the models may improve the overall quality of the received audio signal. The output may be an audio signal with fewer errors and enhanced intelligibility.

In scenarios where both ambient noise and transmission channel noise are present, deterministic noise suppression models may integrate multiple signal processing techniques to address multiple noise types simultaneously. The input audio signal, which may contain speech, ambient noise, and/or transmission channel noise, may processed through a combination of methods, such as sequential filtering, adaptive filtering, etc. Sequential filtering may include first applying spectral subtraction to reduce ambient noise, enhancing the speech components. Subsequently, channel equalization can correct transmission-induced distortions. The output may be an audio signal with both types of noise suppressed. Adaptive filtering can include dynamically adjusting filter parameters in response to changes in both environmental noise and transmission conditions. By continuously monitoring the input audio signal, the model can cater to varying noise characteristics, which may result in an output audio signal with enhanced clarity and reduced noise.

By incorporating these deterministic noise suppression models, the noise suppression model library 318 includes models that may be effective in scenarios such as where the noise characteristics are well-understood and relatively consistent. These models may provide reliable performance with lower computational complexity compared to AI/ML-based models, making them suitable for implementation in devices with limited processing capabilities or for applications where computational efficiency is critical. The availability of both AI/ML-based and deterministic models in the library ensures that the transmitting mobile device 102 can select the most appropriate noise suppression strategy based on the specific operational environment and computational resource constraints.

As will be described in detail with reference to the figures, the noise suppression application 320 may manage the overall configuration of noise suppression models across mobile devices participating in a group call (such as the transmitting mobile device 102 and the receiving mobile devices 104). For example, the noise suppression application 320 may monitor audio quality metrics measured at the transmitting mobile device 102 and audio quality metrics measured at the receiving mobile devices 104 and assess the performance of the noise suppression models active at the respective mobile devices. Based on this assessment, the noise suppression application 320 may determine whether adjustments (e.g., adjusting the aggressiveness level of a noise suppression model and/or activation of a new or different noise suppression model) are needed at the transmitting mobile device 102 or at one or more receiving mobile devices 104 to achieve an optimal balance of noise suppression across the participating mobile devices.

In various implementations, the noise suppression application 320 dynamically adjusts the aggressiveness level and/or selection of appropriate noise suppression models (for example, from the noise suppression model library 318 and/or corresponding noise suppression libraries at the receiving mobile devices 104 as may be appropriate) for the transmitting mobile device 102 and/or the receiving mobile devices 104. For example, when the metrics indicate that multiple receiving mobile devices 104 are experiencing audio degradation (e.g., reporting audio quality metrics below a predefined threshold), the noise suppression application 320 may adjust the aggressiveness level of the first noise suppression model at the transmitting mobile device 102.

Conversely, when only specific receiving mobile devices 104 report degraded audio quality, the noise suppression application 320 may transmit commands to those selected devices, instructing them to adjust the aggressiveness levels of their respective noise suppression models. This targeted approach may allow the noise suppression application 320 to address audio quality issues at individual receiving mobile devices 104 without affecting other devices that are already receiving optimized audio. By coordinating these adjustments across all mobile devices in the group call, the noise suppression application 320 may ensure that each mobile device processes the audio signal optimally according to its unique noise environment.

In addition to managing aggressiveness levels, the noise suppression application 320 may select suitable noise suppression models based on factors such as the current noise environment, the presence of connected audio accessories, and the geographic locations of the devices. For instance, when the transmitting mobile device 102 determines that its location is within a predefined area with known noise characteristics, the noise suppression application 320 may activate a noise suppression model corresponding to that area and select an aggressiveness level appropriate for the defined area. Similarly, when an audio accessory is connected to the transmitting mobile device 102, the noise suppression application 320 may select a less aggressive noise suppression model to account for the accessory's audio input capabilities and may transmit an indication to the receiving mobile devices 104 that the audio accessory is connected.

In various implementations, the noise suppression application 320 determines whether each mobile device in the system is acting as a transmitting device or as a receiving device. The noise suppression application 320 may activate a noise suppression model optimized for addressing ambient noise at the transmitting mobile device 102 and transmit commands to the corresponding noise suppression applications at the receiving mobile devices 104 to activate a noise suppression model optimized for addressing transmission channel noise at each receiving mobile device 104.

By orchestrating the selection and configuration of noise suppression models across all participating devices, the noise suppression application 320 may achieve a balanced and coordinated noise suppression strategy. This dynamic management may address the technical challenges associated with varied and dynamic noise environments, ensuring optimal audio quality and intelligibility for all devices on the call. Thus, the noise suppression application 320 may effectively prevent issues such as overprocessing or underprocessing of audio signals by continuously adapting to the real-time conditions of the communication system 100.

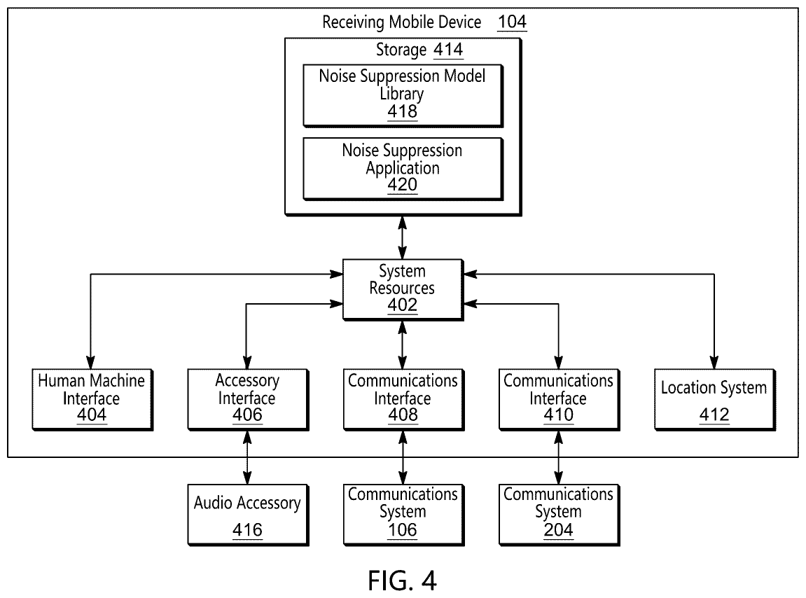

FIG. 4 is a block diagram illustrating a receiving mobile device 104, according to some examples. In the implementation of FIG. 4, the receiving mobile device 104 includes system resources 402, human machine interfaces 404, an accessory interface 406, a communications interface 408, a communications interface 410, a location system 412, and/or non-transitory computer-readable storage media such as storage 414. The system resources 402 may include one or more electronic processors and/or one or more graphics processing units for executing instructions stored in the storage 414, volatile computer memory, non-volatile computer memory, and/or one or more system buses interconnecting the components of the receiving mobile device 104 (such as any of the previously described components).

The human machine interfaces 404 may include one or more input devices and/or one or more output devices designed to facilitate user interaction and/or enhance operational functionality, such as any of the input and/or output devices previously described with reference to the human machine interfaces 304 of the transmitting mobile device 102. The accessory interface 406 may include one or more connection mechanisms designed to attach an audio accessory 416 to the receiving mobile device 104. The accessory interface 406 and the audio accessory 416 may be any of the accessory interfaces 306 and audio accessories 316 previously described with reference to the transmitting mobile device 102.

The communications interface 408 may include one or more components configured to facilitate communication via the communications system 106. For example, the communications interface 408 may include one or more transceivers and associated circuitry for handling RF communications, allowing the receiving mobile device 104 to send and/or receive unidirectional or bidirectional audio and/or data transmissions over the communications system 106. The communications interface 410 may include one or more components configured to facilitate communication via the communications system 204. For example, the communications interface 410 may include one or more transceivers and associated circuitry for handling data communications via the communications system 204.

The location system 412 may include one or more components configured to determine the geographic location of the transmitting mobile device 102. For example, the location system 412 may include any of the components previously described with reference to the location system 312 of the transmitting mobile device 102. In the example of FIG. 4, the storage 414 includes a noise suppression model library 418 and a noise suppression application 420. The noise suppression model library 418 may include any of the noise suppression models previously described with reference to the noise suppression model library 318 of the transmitting mobile device 102.

As will be described in detail with reference to the figures, the noise suppression application 420 may manage the configuration and operation of the noise suppression models at the receiving mobile device 104. Unlike the noise suppression application 320 at the transmitting mobile device 102, which may orchestrate noise suppression across multiple devices, the noise suppression application 420 may operate under the guidance of commands received from the transmitting mobile device 102 or the orchestration platform 202. The noise suppression application 420 may adjust the aggressiveness level of the active noise suppression model from the noise suppression model library 418 in response to received commands, ensuring that the processing of the audio signal is optimized according to instructions from the transmitting mobile device 102.

For example, the noise suppression application 420 may receive a command via the communications interface 408 or 410 instructing it to adjust the aggressiveness level of the noise suppression model activated at the receiving mobile device 104. In response, the noise suppression application 420 may increase or decrease the noise suppression level by modifying parameters of the active noise suppression model. Additionally, when the receiving mobile device 104 determines that its location is within a defined area with specific noise characteristics, the noise suppression application 420 may activate a noise suppression model corresponding to that area and/or select an appropriate aggressiveness level.

The noise suppression application 420 may also monitor local audio quality metrics at the receiving mobile device 104 transmit the audio quality metrics back to the transmitting mobile device 102 or the orchestration platform 202 via the communications interface 408 or 410. This feedback allows the transmitting mobile device 102 to assess the performance of the noise suppression configurations across the communication system 100 and determine whether further adjustments are needed. By following instructions from the transmitting mobile device 102 and providing relevant feedback, the noise suppression application 420 may ensure that the receiving mobile device 104 contributes to the overall goal of maintaining optimal audio quality and intelligibility within the group call.

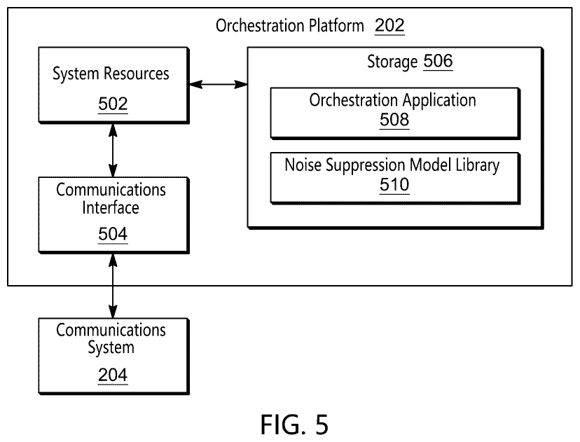

FIG. 5 is a block diagram illustrating an orchestration platform 202, according to some examples. In the implementation of FIG. 5, the orchestration platform 202 includes system resources 502, a communications interface 504, and/or non-transitory computer-readable storage media such as storage 506. The system resources 502 may include one or more electronic processors and/or one or more graphics processing units for executing instructions stored in the storage 506, volatile computer memory, non-volatile computer memory, and/or one or more system buses interconnecting the components of the orchestration platform 202 (such as any of the previously described components).

The communications interface 504 may include one or more components configured to facilitate communication via the communications system 204. For example, the communications interface 504 may include one or more transceivers and associated circuitry for handling data communications via the communications system 204. In the example of FIG. 5, the storage 506 includes an orchestration application 508 and a noise suppression model library 510.

As will be described in detail with reference to the figures, the orchestration application 508 may manage the overall configuration of noise suppression models across mobile devices participating in the group call (such as, for example, the transmitting mobile device 102 and the receiving mobile devices 104). Operating from the orchestration platform 202, the orchestration application 508 may provide centralized control over noise suppression strategies within the communications system 100.

For example, the orchestration application 508 may monitor audio quality metrics received from the noise suppression applications 320 and 420 running on the transmitting mobile device 102 and the receiving mobile devices 104, respectively. The audio quality metrics may indicate the quality of the audio at each respective mobile device. By collecting and analyzing these metrics, the orchestration application 508 may assess the performance of the noise suppression models active at the respective mobile devices.

Based on this assessment, the orchestration application 508 may determine whether adjustments are needed at the transmitting mobile device 102 or at one or more receiving mobile devices 104 to achieve an optimal balance of noise suppression across the participating mobile devices. For example, in response to the metrics indicating that multiple receiving mobile devices 104 are experiencing audio degradation (e.g., reporting audio quality metrics below a predefined threshold), the orchestration application 508 may send a command to the transmitting mobile device 102 to adjust the aggressiveness level of its active noise suppression model.

Conversely, in response to only specific receiving mobile devices 104 reporting degraded audio quality, the orchestration application 508 may transmit commands to those selected devices, instructing them to adjust the aggressiveness levels of their respective noise suppression models. This targeted approach may allow the orchestration application 508 to address audio quality issues at individual receiving mobile devices 104 without affecting other devices that are already receiving optimized audio. By coordinating these adjustments across all mobile devices in the group call, the orchestration application 508 may ensure that each mobile device processes the audio signal optimally according to its unique noise environment.

In addition to managing aggressiveness levels, the orchestration application 508 may select suitable noise suppression models (for example, from any of the noise suppression model libraries 318, 418, and 510) based on factors such as the current noise environment, the presence of connected audio accessories, and the geographic locations of the devices. For instance, when the orchestration application 508 determines that the transmitting mobile device 102 is located within a predefined area with known noise characteristics, it may send a command to the transmitting mobile device 102 to activate a noise suppression model corresponding to that area and select an aggressiveness level appropriate for the defined area. Similarly, when an audio accessory is connected to the transmitting mobile device 102, the orchestration application 508 may instruct the device to select a less aggressive noise suppression model to account for the accessory's audio input capabilities and may transmit an indication to the receiving mobile devices 104.

In various implementations, the orchestration application 508 determines whether each mobile device in the system is acting as a transmitting device or as a receiving device. The orchestration application 508 may transmit a command to the noise suppression application 320 at the transmitting mobile device 102 to activate a noise suppression model optimized for addressing ambient noise at the transmitting mobile device 102 and transmit commands to the noise suppression applications 420 at the receiving mobile devices 104 to activate a noise suppression model optimized for addressing transmission channel noise at each receiving mobile device 104.

By orchestrating the selection and configuration of noise suppression models across all participating devices from a centralized platform, the orchestration application 508 may achieve a balanced and coordinated noise suppression strategy. This centralized management may address the technical challenges associated with varied and dynamic noise environments, ensuring optimal audio quality and intelligibility for all devices on the call. Thus, the orchestration application 508 may effectively prevent issues such as overprocessing or underprocessing of audio signals by continuously adapting to the real-time conditions of the communication system 100.

The noise suppression model library 510 may include a comprehensive collection of noise suppression models, for example, including those described with reference to the noise suppression model libraries 318 and 418 of the transmitting mobile device 102 and the receiving mobile devices 104, respectively. The noise suppression model library 510 may store a wide variety of noise suppression models implemented using artificial intelligence (AI) and machine learning (ML) techniques, as well as deterministic signal processing methods. The models may be optimized to mitigate ambient noise, transmission channel noise, or both, and may be tailored for specific environments, noise types, or device capabilities.

In addition to the models available on the mobile devices, the noise suppression model library 510 may include additional models not present on the transmitting mobile device 102 or the receiving mobile devices 104. These additional models may be developed to address new noise environments, incorporate advancements in noise suppression algorithms, or cater to updates in device hardware capabilities. The orchestration application 508 may manage the distribution of these models to the mobile devices as needed.

The orchestration application 508 may transmit noise suppression models from the noise suppression model library 510 to the transmitting mobile device 102 and the receiving mobile devices 104 via the communications system 204. This transmission may occur when updating existing models on the devices or when adding new models to address specific noise conditions encountered by the devices. For example, when a mobile device enters a new environment with unique noise characteristics not adequately handled by its current noise suppression models, the orchestration application 508 may provide a suitable model from the noise suppression model library 510.

By dynamically distributing noise suppression models, the orchestration application 508 may ensure that the transmitting mobile device 102 and the receiving mobile devices 104 have access to the most appropriate noise suppression strategies for their current operating conditions. This capability may enhance the adaptability of the communication system 100 to varying and unforeseen noise environments, contributing to optimal audio quality and intelligibility across the system.

Moreover, the orchestration application 508 may manage version control and compatibility of noise suppression models across the communication system 100. By coordinating updates and ensuring that mobile devices are equipped with compatible models, the orchestration application 508 can prevent conflicts or inconsistencies that might arise from mismatched noise suppression strategies. This centralized management contributes to the overall effectiveness of the noise suppression techniques employed within the communications system 100.

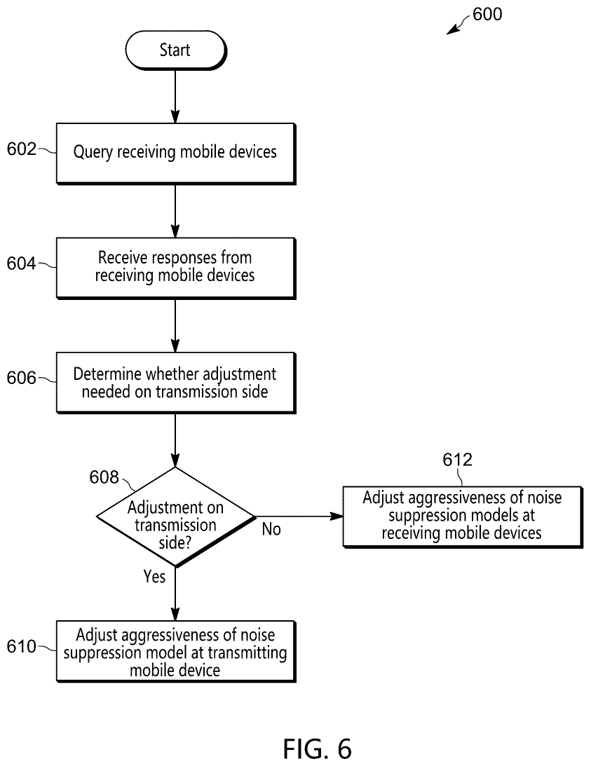

FIG. 6 is a flowchart of a process 600 for determining whether adjustments to noise suppression models are needed at the transmitting mobile device 102 or at one or more receiving mobile devices 104, according to some examples. Although the operations of the process 600 are illustrated with reference to particular examples disclosed herein (e.g., components of the system 100 such as the transmitting mobile device 102, receiving mobile devices 104, orchestration platform 202, etc.), the process 600 may be used in any suitable setting to perform any suitable support operations. Operations are illustrated once each and in a particular order in FIG. 6, but the operations may be reordered and/or repeated as desired and appropriate (e.g., different operations performed may be performed in parallel, as suitable).

In the example process 600, the transmitting mobile device 102 or the orchestration platform 202 queries the receiving mobile devices 104 participating in the group call for audio quality metrics (at block 602). In various implementations, the noise suppression application 320 transmits a request to the noise suppression applications 420 via the communications system 106. In some examples, the noise suppression application 320 transmits the request to the noise suppression applications 420 via the communications system 204. In various implementations, the orchestration application 508 transmits the request to the noise suppression applications 420 via the communications system 204.

The noise suppression application 420 at each receiving mobile device 104 computes the audio quality metric indicative of the audio signal transmitted by the transmitting mobile device 102 as received at the respective receiving mobile device 104. Examples of suitable audio quality metrics may include measurements such as signal-to-noise ratio (SNR), received signal-to-noise ratio (RxSNR), perceptual objective listening quality analysis (POLQA), short-time objective intelligibility (STOI), signal-to-noise ratio improvement (SNRI), etc. Audio quality metrics may provide a quantitative assessment of the audio quality and/or intelligibility.

SNR may measure the ratio of the power of the desired signal (speech) to the power of background noise within the received audio signal. A higher SNR may indicate that the speech signal is stronger relative to the noise, resulting in better audio quality. The noise suppression application 420 may compute the SNR by segmenting the received audio signal into frames and estimating the power of the speech and noise components in each frame. This can be achieved using techniques such as voice activity detection to identify speech segments and noise estimation algorithms to measure background noise levels. The computed SNR may provide an overall indication of the clarity of the speech signal at the receiving mobile device 104

RxSNR may be similar to SNR but may specifically refer to the SNR measured at the receiver's end, accounting for the effects of transmission channel noise and other distortions introduced during signal propagation. The noise suppression application 420 may compute RxSNR by analyzing the strength of the received signal and comparing it to the noise floor of the receiver's environment. This may involve measuring the power of the received signal during active speech periods and the power of the noise during silent periods. RxSNR may provide insight into how transmission conditions impact the audio quality experienced by the receiving mobile device 104.

POLQA is an advanced algorithm that may predict the perceived audio quality of a speech signal based on models of human auditory perception. POLQA may include computing a mean opinion score (MOS) that reflects the subjective quality experienced by listeners. The noise suppression application 420 may compute POLQA scores by comparing the received audio signal to a reference clean signal, assessing factors such as distortion, delay, and noise. Since the exact transmitted signal may not be available at the receiver, the noise suppression application 420 may use standardized reference signals or estimated clean signals based on known characteristics of the transmitted audio. POLQA is particularly effective in evaluating the impact of both noise and processing artifacts on perceived audio quality.

STOI is a metric that may quantify the intelligibility of speech signals, especially in the presence of noise or distortions. STOI may evaluate the correlation between the clean and degraded speech signals over short time frames, producing a score between 0 and 1, where higher values may indicate better intelligibility. The noise suppression application 420 may compute STOI by segmenting the received audio signal and the reference clean signal into short overlapping time frames, transforming them into the frequency domain, and calculating the correlation coefficients. Similar to POLQA, when the exact reference signal is not available, the application may use an estimated clean signal. STOI is effective in assessing how well the speech content can be understood by listeners under varying noise conditions.

SNRI may measure the improvement in SNR achieved by the noise suppression process. It is calculated by comparing the SNR of the audio signal before and after noise suppression. The noise suppression application 420 may compute SNRI by first estimating the SNR of the received audio signal prior to applying its noise suppression model and then estimating the SNR after processing. The difference between these two SNR values represents the SNRI. A higher SNRI indicates that the noise suppression model may be effectively enhancing the audio quality by reducing noise levels relative to the speech signal.

By computing these audio quality metrics, the noise suppression application 420 provides valuable feedback on the performance of the noise suppression models and the overall audio quality experienced at each receiving mobile device 104. The computed audio quality metrics can be transmitted back to the transmitting mobile device 102 or the orchestration platform 202 via the communications interface 408 or 410. This feedback enables the transmitting mobile device 102 or the orchestration platform 202 to assess whether adjustments to the noise suppression aggressiveness levels or model selection are necessary to optimize audio quality across the communication system 100.

In the example process 600, the transmitting mobile device 102 or the orchestration platform 202 receives responses including the audio quality metrics from the receiving mobile devices 104 (at block 604). In various implementations, the noise suppression application 320 receives the responses. In some examples, the noise suppression application 420 receives the responses. In the example process 600, the transmitting mobile device 102 or the orchestration platform 202 determines whether adjustments are needed on the transmission side (at block 606). For example, the noise suppression application 320 or the orchestration application 508 may initiate a voting process and determine a count of receiving mobile devices 104 reporting an audio quality metric falling below a threshold. The threshold may be a user-configurable threshold or a preset threshold.

The noise suppression application 320 or the orchestration application 508 may determine that an adjustment is needed to the noise suppression model activated at the transmission side (e.g., the transmitting mobile device 102) in response to the count being above a threshold. For example, the threshold may be set to a number corresponding to about half of the number of receiving mobile devices 104 participating in the group call. Thus, the noise suppression application 320 or the orchestration application 508 may determine that the adjustment is needed to the noise suppression model at the transmission side in response to a majority of receiving mobile devices 104 reporting audio quality metrics falling below the threshold.

In response to determining that an adjustment is needed on the transmission side (“YES” at decision block 608), the transmitting mobile device 102 adjusts the aggressiveness of the noise suppression model active at the transmitting mobile device 102 (at block 610). For example, the noise suppression application 320 adjusts the aggressiveness of the noise suppression model active at the transmitting mobile device 102. In various implementations, the orchestration platform 202 transmits a command to the transmitting mobile device 104 to adjust the aggressiveness of the noise suppression model active at the transmitting mobile device 102.

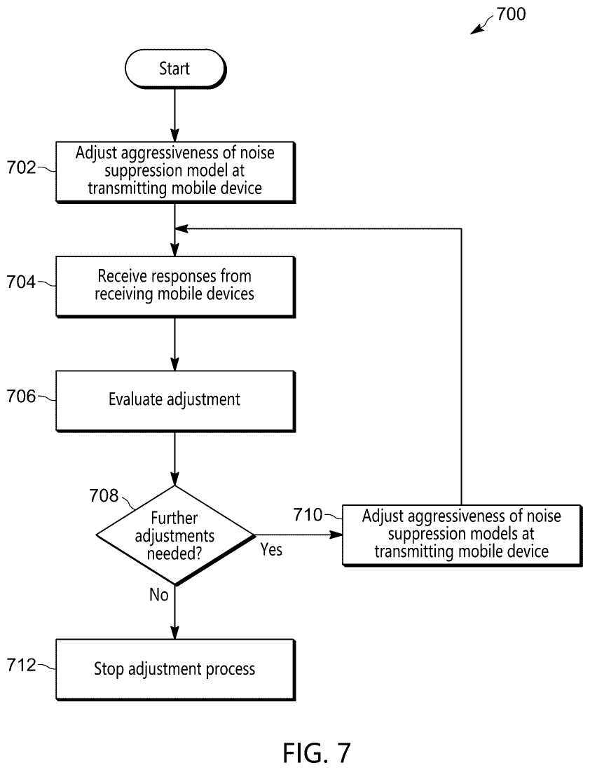

FIG. 7 is a flowchart of a process 700 for adjusting the aggressiveness of the noise suppression model at the transmitting mobile device 102, according to some examples. Although the operations of the process 700 are illustrated with reference to particular examples disclosed herein (e.g., components of the system 100 such as the transmitting mobile device 102, receiving mobile devices 104, orchestration platform 202, etc.), the process 700 may be used in any suitable setting to perform any suitable support operations. Operations are illustrated once each and in a particular order in FIG. 7, but the operations may be reordered and/or repeated as desired and appropriate (e.g., different operations performed may be performed in parallel, as suitable).

In the example process 700, the transmitting mobile device 102 makes an incremental adjustment to the aggressiveness of the noise suppression model active at the transmitting mobile device 102 (at block 702). For example, the noise suppression application 320 increases or decreases the aggressiveness of the active noise suppression model. In various implementations, the noise suppression application 320 computes a difference between the audio quality metric threshold and an average of the audio quality metrics reported by the receiving mobile devices 104 and uses the computed difference as an amount of adjustment for the active noise suppression model. After adjusting the aggressiveness of the noise suppression model, the transmitting mobile device 102 transmits an new audio signal—processed by the adjusted noise suppression model at the transmission side—to the receiving mobile devices 104. The receiving mobile devices 104 compute updated audio quality metrics indicating the quality of the new audio signal received at each respective receiving mobile device 104 and report the updated audio quality metrics to the transmitting mobile device 102 or the orchestration platform 202. In various implementations, the noise suppression application 420 at each receiving mobile device 104 computes and transmits the updated audio quality metric to the noise suppression application 320. In some examples, the noise suppression application 420 at each receiving mobile device 104 computes and transmits the updated audio quality metric to the orchestration application 508.

In the example process 700, the transmitting mobile device 102 or the orchestration platform 202 receives the responses from the receiving mobile devices 104 (at block 704) and evaluates the updated audio quality metrics to determine whether further adjustments are needed to the noise suppression model at the transmitting mobile device 102 (at block 706). For example, the noise suppression application 320 or the orchestration application 508 may determine further adjustments are needed in response to the count of receiving mobile devices 104 reporting an updated audio quality metric below the audio quality metric threshold remaining below the number of receiving mobile devices threshold (e.g., about half the number of receiving mobile devices 104).

In response to determining that further adjustments are needed (“YES” at decision block 708), the transmitting mobile device 102 continues adjusting the aggressiveness of the noise suppression model at the transmitting mobile device 102 at block 710 and the process 700 returns to block 704. In various implementations, the noise suppression application 320 adjusts the aggressiveness of the noise suppression model as described with reference to block 702. In some examples, the orchestration application 508 transmits a command to the noise suppression application 320 to adjust the aggressiveness of the noise suppression model and the noise suppression application 320 adjusts the aggressiveness of the noise suppression application as described with reference to block 702.

In response to determining that further adjustments are not needed (“NO” at decision block 708), adjustment process stops at block 712 until a new determination that an adjustment to the aggressiveness of the noise suppression model at the transmitting mobile device 102 is needed is made, for example, at block 610 of the process 600.

Returning to FIG. 6, in response to determining that adjustments are not needed on the transmission side (“NO” at decision block 608), the transmitting mobile device 102 or the orchestration platform 202 proceeds to adjust the aggressiveness of noise suppression models at individual receiving mobile devices 104, as necessary (at block 612).

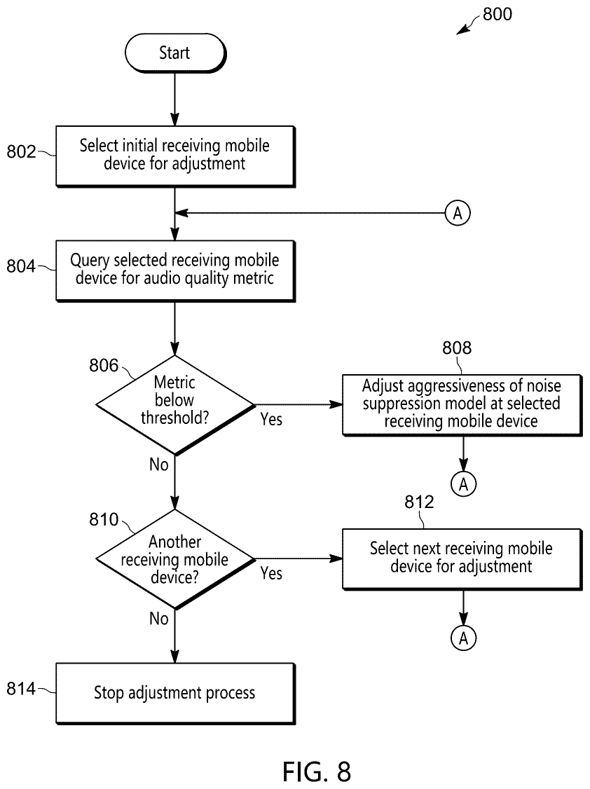

FIG. 8 is a flowchart of a process 800 for adjusting the aggressiveness of the noise suppression model at one or more receiving mobile devices 104, according to some examples. Although the operations of the process 800 are illustrated with reference to particular examples disclosed herein (e.g., components of the system 100 such as the transmitting mobile device 102, receiving mobile devices 104, orchestration platform 202, etc.), the process 800 may be used in any suitable setting to perform any suitable support operations. Operations are illustrated once each and in a particular order in FIG. 8, but the operations may be reordered and/or repeated as desired and appropriate (e.g., different operations performed may be performed in parallel, as suitable).

In the example process 800, the transmitting mobile device 102 or the orchestration platform 202 selects an initial receiving mobile device 104 from the group of receiving mobile devices 104 participating in the group call (at block 802). For example, the noise suppression application 320 or the orchestration application selects the initial receiving mobile device 104. In the example process 800, the transmitting mobile device 102 or the orchestration platform 202 queries the selected receiving mobile device 104 for an audio quality metric (at block 804). For example, the noise suppression application 320 or the orchestration application 508 transmits a query to the noise suppression application 420 at the selected receiving mobile device 104, and the noise suppression application 420 computes an audio quality metric (for example, according to any of the previously described techniques) for the audio signal transmitted from the transmitting mobile device 102 received at the selected receiving mobile device 104.

The selected receiving mobile device 104 transmits the audio quality metric to the transmitting mobile device 102 or the orchestration platform 202, and the transmitting mobile device 102 or the orchestration platform 202 determines whether the audio quality metric is below the audio quality metric threshold (at decision block 806). For example, the noise suppression application 320 or the orchestration application 508 receives the audio quality metric and determines whether the metric is below the audio quality metric threshold. Determining that the audio quality metric is below the audio quality metric threshold may indicate that the noise suppression model at the selected receiving mobile device 104 needs to be adjusted.

In response to determining that the audio quality metric is below the audio quality metric threshold (“YES” at decision block 806), the transmitting mobile device 102 or the orchestration platform 202 transmits a command to the selected receiving mobile device 104 to adjust the aggressiveness of the noise suppression model active at the selected receiving mobile device 104 (at block 808). For example, the noise suppression application 320 or the orchestration application 508 transmits the command to the noise suppression application 420 at the selected receiving mobile device 104, and the noise suppression application 420 increases or decreases the aggressiveness level of the noise suppression model by an increment. In various implementations, the increment may be computed as a difference between the audio quality threshold and the audio quality metric reported by the selected receiving mobile device 104. After adjusting the aggressiveness of the noise suppression model at the selected receiving mobile device (at block 808), the process 800 proceeds back to block 804.

In response to determining that the audio quality metric is not below the audio quality metric threshold (“NO” at decision block 806), the transmitting mobile device 102 or the orchestration platform 202 (for example, the noise suppression application 320 or the orchestration application 508) determines whether there is another receiving mobile device 104 participating in the group call whose noise suppression model has not been adjusted (at decision block 810). In response to determining that another receiving mobile device 104 that has not been adjusted is participating in the group call (“YES” at decision block 810), the transmitting mobile device 102 or the orchestration platform 202 (e.g., the noise suppression application 320 or the orchestration application 508) selects the next receiving mobile device 104 for adjustment (at block 812) and the process 800 proceeds back to block 804. In response to determining that an another receiving mobile device 104 that has not been adjusted is not participating in the group call or all receiving mobile devices 104 participating in the group call have been through the adjustment process (“NO” at decision block 810), the transmitting mobile device 102 or the orchestration platform (for example, the noise suppression application 320 or the orchestration application 508) stops the adjustment process at block 814.

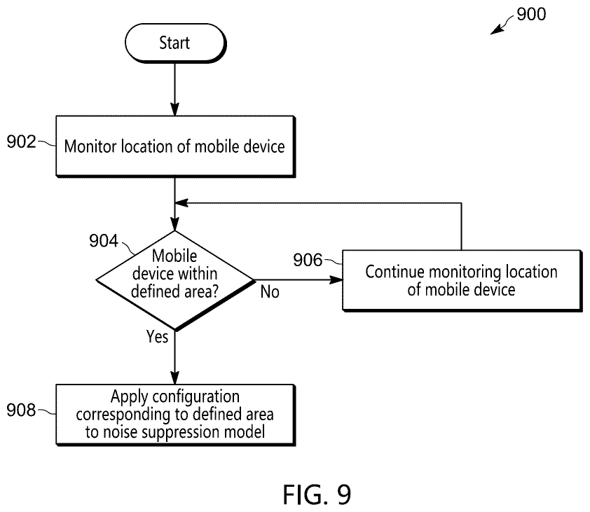

FIG. 9 is a flowchart of a process 900 for automatically configurating a noise suppression model based on a location of a mobile device, according to some examples. Although the operations of the process 900 are illustrated with reference to particular examples disclosed herein (e.g., components of the system 100 such as the transmitting mobile device 102, receiving mobile devices 104, orchestration platform 202, etc.), the process 900 may be used in any suitable setting to perform any suitable support operations. Operations are illustrated once each and in a particular order in FIG. 9, but the operations may be reordered and/or repeated as desired and appropriate (e.g., different operations performed may be performed in parallel, as suitable).

In the example process 900, the location of a mobile device (such as the transmitting mobile device 102 or one of the receiving mobile devices 104) is monitored (at block 902). In various implementations, the noise suppression application 320 or 420 monitors the location system 312 or 412 to determine the location of the mobile device. In some examples, the orchestration application 508 monitors the location of the mobile device. The noise suppression application 320, noise suppression application 420, or the orchestration application 508 determines whether the mobile device is within a defined area (at decision block 904). The defined area may be a geofenced area having known noise characteristics. For example, the noise suppression application 320, noise suppression application 420, or the orchestration application 508 may have noise identification and/or noise severity information stored for the defined area.

In response to determining that the location of the mobile device is not within the defined area (“NO” at decision block 904), the noise suppression application 320, noise suppression application 420, or the orchestration application 508 continues monitoring the location of the mobile device (at block 906) and the process 900 proceeds back to decision block 904. In response to determining that the location of the mobile device is within the defined area (“YES” at decision block 904), the noise suppression application 320, noise suppression application 420, or the orchestration application 508 applies a configuration corresponding to the defined area to the noise suppression model at the mobile device (at block 908).

For example, the noise suppression application 320 or 420 may automatically select and activate a noise suppression model from the noise suppression model library 318 or 418 corresponding to the noise identification information and/or set the aggressiveness level of the noise suppression model based on the noise severity information. In various implementations, the orchestration application 508 may transmit a command to the noise suppression application 320 or 420 to automatically select and activate a noise suppression model from the noise suppression model library 318 or 418 corresponding to the noise identification information and/or set the aggressiveness level of the noise suppression model based on the noise severity information.

In some examples, the orchestration application 508 selects a noise suppression model from the noise suppression model library 510 according to the noise identification information and/or noise severity information, transmits the selected noise suppression model to the noise suppression application 320 or 420, and commands the noise suppression application 320 or 420 to activate the noise suppression model and/or set the aggressiveness level of the noise suppression model based on the noise severity information.

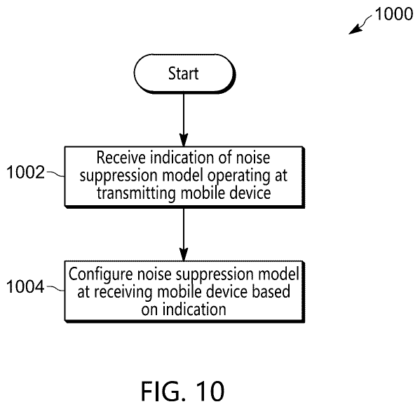

FIG. 10 is a flowchart of a process 1000 for configuring a noise suppression model at a receiving mobile device 104, according to some examples. In the example process 1000, the receiving mobile device 104 receives an indication of a noise suppression model operating at the transmitting mobile device 102 (at block 1002). For example, the noise suppression application 420 receives the indication from the noise suppression application 320 or the orchestration application 508. In various implementations, the indication signals whether a noise suppression model is active at the transmitting mobile device 102. In some examples, the indication indicates whether a less aggressive noise suppression model or a more aggressive noise suppression model is active at the transmitting mobile device 102. In various implementations, the noise suppression application 320 may activate the less aggressive noise suppression model in response to the audio accessory 316 (such as an external microphone, which may bypass an adaptive beamformer microphone of the human machine interfaces 304) being connected via the accessory interface 306, and may activate the more aggressive noise suppression model in response to the audio accessory 316 not being connected.

In the example process 1000, the receiving mobile device 104 configures a noise suppression model at the receiving mobile device 104 based on the received indication (at block 1004). In various implementations, when the indication shows that a noise suppression model (such as a noise suppression model targeting ambient noise) is active at the transmitting mobile device 102, then the noise suppression application 420 activates a noise suppression model at the receiving mobile device 104 that targets transmission channel noise. In some examples, when the indication shows that a noise suppression model is not active at the transmitting mobile device 102, then the noise suppression application 420 activates a noise suppression model at the receiving mobile device 104 that targets both ambient noise and transmission channel noise. When the indication shows that the less aggressive model is active or that the audio accessory 316 is connected to the accessory interface 306 at the transmitting mobile device, then the noise suppression application 420 increases the aggressiveness of the noise suppression model at the receiving mobile device 104.

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed examples. Thus the following claims are hereby incorporated into the Detailed Description, with each claim standing on its own as a separately claimed subject matter.

We claim:

1. A transmitting mobile device, comprising:
non-transitory computer-readable media storing instructions; and
an electronic processor configured to execute the instructions to:
transmit a query to a plurality of receiving mobile devices requesting an audio quality metric for an audio transmission from the transmitting mobile device as received by each receiving mobile device, the plurality of receiving mobile devices and the transmitting mobile device being part of a land mobile radio call group,
receive a response from each receiving mobile device, each response including the audio quality metric,
determine a count of receiving mobile devices reporting audio quality metrics below a first threshold, and
in response to the count being below a second threshold, adjust an aggressiveness level of a first noise suppression model at the transmitting mobile device.

2. The transmitting mobile device of claim 1, wherein the electronic processor is further configured to execute the instructions to:
after adjusting the aggressiveness level of the first noise suppression model, transmit a second query to the plurality of receiving mobile devices for an updated audio quality metric from each receiving mobile device;
receive an updated response from each receiving mobile device, each updated response including the updated audio quality metric;
determine an updated count of receiving mobile devices reporting updated audio quality metrics below the first threshold; and
in response to the updated count being below the second threshold, further adjust the aggressiveness level of the first noise suppression model.

3. The transmitting mobile device of claim 1, wherein the electronic processor is further configured to execute the instructions to:
in response to the count not being below the second threshold, transmit a first command to a selected receiving mobile device from the plurality of receiving mobile devices in response to the audio quality metric reported by the selected receiving mobile device being below the first threshold, the first command instructing the selected receiving mobile device to adjust an aggressiveness level of a second noise suppression model at the selected receiving mobile device.

4. The transmitting mobile device of claim 3, wherein the electronic processor is further configured to execute the instructions to:
after transmitting the first command, receive an updated response message including an updated audio quality metric from the selected receiving mobile device and, in response to determining that the updated audio quality metric is below the first threshold, transmit a second command to the selected receiving mobile device, the second command instructing the selected receiving mobile device to adjust the aggressiveness level of the second noise suppression model.

5. The transmitting mobile device of claim 1, wherein the electronic processor is further configured to execute the instructions to adjust the aggressiveness level of the first noise suppression model by increasing or decreasing a noise suppression level of the first noise suppression model.

6. The transmitting mobile device of claim 1, wherein the electronic processor is further configured to execute the instructions to:
in response to determining that a location of the transmitting mobile device is within a defined area, activate a noise suppression model corresponding to the defined area as the first noise suppression model.

7. The transmitting mobile device of claim 1, wherein the electronic processor is further configured to execute the instructions to:
in response to determining that a location of the transmitting mobile device is within a defined area, select an aggressiveness level for the first noise suppression model corresponding to the defined area.

8. The transmitting mobile device of claim 1, wherein the electronic processor is further configured to execute the instructions to:
in response to determining that an audio accessory is connected to the transmitting mobile device, activate a third noise suppression model, the third noise suppression model being less aggressive than the first noise suppression model; and
transmit an indication that the audio accessory is connected to at least one of the plurality of receiving mobile devices;
wherein the audio accessory includes a single-microphone audio accessory.

9. A non-transitory computer-readable storage medium comprising executable instructions, wherein, when executed by an electronic processor, the executable instructions cause the electronic processor to:
transmit a query to a plurality of receiving mobile devices requesting an audio quality metric for an audio transmission from a transmitting mobile device as received by each receiving mobile device, the plurality of receiving mobile devices and the transmitting mobile device being part of a land mobile radio call group;
receive a response from each receiving mobile device, each response including the audio quality metric;
determine a count of receiving mobile devices reporting audio quality metrics below a first threshold; and
in response to the count being below a second threshold, adjust an aggressiveness level of a first noise suppression model at the transmitting mobile device.

10. The non-transitory computer-readable storage medium of claim 9, wherein, when executed by the electronic processor, the executable instructions cause the electronic processor to adjust the aggressiveness level of the first noise suppression model at the transmitting mobile device by transmitting a first command to the transmitting mobile device.

11. The non-transitory computer-readable storage medium of claim 9, wherein, when executed by the electronic processor, the executable instructions further cause the electronic processor to:
after adjusting the aggressiveness level of the first noise suppression model, transmit a second query to the plurality of receiving mobile devices for an updated audio quality metric from each receiving mobile device;
receive an updated response from each receiving mobile device, each updated response including the updated audio quality metric;
determine an updated count of receiving mobile devices reporting updated audio quality metrics below the first threshold; and
in response to the updated count being below the second threshold, transmit a second command to the transmitting mobile device to further adjust the aggressiveness level of the first noise suppression model.

12. The non-transitory computer-readable storage medium of claim 9, wherein, when executed by the electronic processor, the executable instructions further cause the electronic processor to:
in response to the count not being below the second threshold, transmit a first command to a selected receiving mobile device from the plurality of receiving mobile devices in response to the audio quality metric reported by the selected receiving mobile device being below the first threshold, the first command instructing the selected receiving mobile device to adjust an aggressiveness level of a second noise suppression model at the selected receiving mobile device.

13. The non-transitory computer-readable storage medium of claim 12, wherein when executed by the electronic processor, the executable instructions further cause the electronic processor to:
after transmitting the first command, receive an updated response message including an updated audio quality metric from the selected receiving mobile device and, in response to determining that the updated audio quality metric is below the first threshold, transmit a second command to the selected receiving mobile device, the second command instructing the selected receiving mobile device to adjust the aggressiveness level of the second noise suppression model.

14. The non-transitory computer-readable storage medium of claim 13, wherein, when executed by the electronic processor, the executable instructions cause the electronic processor to adjust the aggressiveness level of the first noise suppression model by increasing or decreasing a noise suppression level of the first noise suppression model.

15. The non-transitory computer-readable storage medium of claim 9, wherein, when executed by the electronic processor, the executable instructions further cause the electronic processor to:
in response to determining that a location of the transmitting mobile device is within a defined area, activate a noise suppression model corresponding to the defined area as the first noise suppression model and select an aggressiveness level for the first noise suppression model corresponding to the defined area.

16. The non-transitory computer-readable storage medium of claim 15, wherein, when executed by the electronic processor, the executable instructions cause the electronic processor to activate the noise suppression model corresponding to the defined area as the first noise suppression model and select an aggressiveness level for the first noise suppression model by transmitting a third command to the transmitting mobile device.

17. The non-transitory computer-readable storage medium of claim 12, wherein, when executed by the electronic processor, the executable instructions cause the electronic processor to, in response to determining that a location of the selected receiving mobile device is within a defined area, transmit a fourth command to the selected receiving mobile device to activate a noise suppression model corresponding to the defined area as the second noise suppression model and select an aggressiveness level for the second noise suppression model corresponding to the defined area.

18. A receiving mobile device, comprising:
non-transitory computer-readable media storing instructions; and
an electronic processor configured to execute the instructions to:
receive a data transmission from a transmitting mobile device, the transmitting mobile device and the receiving mobile device being part of a land mobile radio call group, the data transmission including an indication of whether a first noise suppression model is operating at the transmitting mobile device,
in response to determining that the first noise suppression model is operating at the transmitting mobile device, activate a second noise suppression model at the receiving mobile device,
in response to determining that the first noise suppression model is not operating at the transmitting mobile device, activate a third noise suppression model at the receiving mobile device,
receive a command from the transmitting mobile device, and
in response to receiving the command, adjust an aggressiveness level of the activated noise suppression model by increasing or decreasing a noise suppression level of the activated noise suppression model.

19. The receiving mobile device of claim 18, wherein the electronic processor is further configured to execute the instructions to:
in response to determining that a location of the receiving mobile device is within a defined area, activate a fourth noise suppression model corresponding to the defined area and select an aggressiveness level for the activated noise suppression model corresponding to the defined area.

20. The receiving mobile device of claim 18, wherein:
the second noise suppression model is configured to suppress noise introduced by a radio-frequency transport channel noise; and
the third noise suppression model is configured to suppress an audible noise at the transmitting mobile device.
